(19) United States
(12) Patent Application Publication
(10) Pub. No.: US 2016/0206902 A1
(43) Pub. Date: Jul. 21, 2016

(54) FIRE ESCAPE EMERGENCY DESCENT SYSTEM (EDS)

(71) Applicant: Norman E. Wood, Lynnwood, WA (US)

(72) Inventor: Norman E. Wood, Lynnwood, WA (US)

(21) Appl. No.: 14/936,891

(22) Filed: Nov. 10, 2015

Related U.S. Application Data
(63) Continuation of application No. 13/773,561, filed on Feb. 21, 2013, now abandoned.

(51) Int. Cl. A62B 35/00

(52) U.S. Cl. CPC A62B 35/0018; A62B 35/0037; A62B 35/0043

(57) ABSTRACT

An emergency descent system for use by an individual to effect escape from a building or other elevated structure. The system comprises: an upper vest component for securing about the individual's chest, said vest component including an integral rack; a lower component for securing about both upper legs of the individual; and an elongate section of rope for securing at one end to a fixture on the structure from which the individual can effect gradual descent along said rope as it frictionally engages with the integral rack of the upper vest component. A method of use is also disclosed.

### RELATED APPLICATION(S)

This application is a continuation of co-pending U.S. application Ser. No. 13/773,561, filed on Feb. 21, 2013, which was a perfection of U.S. Provisional Application No. 61/601,078, filed on Feb. 21, 2012, both disclosures of which are fully incorporated by reference herein.

### BACKGROUND OF THE INVENTION

1. Field of the Invention

The present invention relates to an emergency descent system, or “EDS”. More particularly, this invention relates to a more universal EDS that can be stored, easily installed and used for affecting safe escape from the higher levels of a building, home or office, in case of fire or an atypical emergency. This invention uses fireproof rope or cable for lowering an individual in a controlled descent from a higher to lower elevation. Unlike many prior art rescue devices, this invention includes an integral brake and rack that will not require the operator/user to contact or otherwise touch the line/rope during descent.

2. Relevant Art

Descent control devices have been developed with the objective of lowering individuals or objects from a higher to lower elevation. These devices have taken many forms and have utilized a variety of elements. Some are capable of providing a mechanical braking mechanism, such as a deadman or panic control feature, when the device would be used for descent, escape, or rescue purposes.

Concerns with occupational safety have led to the development of mechanisms which enable a worker to lower himself from an elevated position such as a scaffold, crane, lift truck or platform in the event of an emergency. That equipment is, in some respects, similar to known fire escape devices, mountain climbing equipment, and military equipment.

One descent control device with a deadman brake, in the form of a vertical cylindrical drum or capstan about which a rope is wound and a tapered slot through the drum for receiving and releasably gripping the rope, is shown in Varner et al. U.S. Pat. No. No. 4,883,146. That device includes plates on each end of a vertical cylindrical drum or capstan with apertures on each end plate through which the rope is threaded, then wound in two or more turns around the drum.

Tapered slots are well known for releasably fastening ropes, lines and cables. The use of cylindrical capstans for holding and providing a mechanical advantage for tightening ropes is also known. Likewise, a variety of fire escape devices utilize rope wound around a cylinder. See, for example, Budd U.S. Pat. No. 386,237; FitzGerald U.S. Pat. No. 536,866; Howe U.S. Pat. No. 771,251; Thuemer U.S. Pat. No. 946,588; Smith U.S. Pat. No. 1,115,603; Steffen U.S. Pat. No. 4,311,218; and Forrest U.S. Pat. Nos. 4,508,193 and 4,550,801.

In addition, there are known but clearly distinguishable teachings in Hobbs U.S. Pat. No. 3,678,543; Arancio U.S. Pat. No. 3,738,449; Wagner U.S. Pat. No. 4,019,609; Bell et al. U.S. Pat. No. 4,714,135; Varner et al. U.S. Pat. Nos. 5,038,888 and 5,131,491; Bassett U.S. Pat. No. 6,131,697; Harbers Jr. U.S. Pat. No. 6,585,082; Metz U.S. Pat. No. 6,817,443; Henson U.S. Pat. No. 6,823,966; and Halevy U.S. Pat. No. 7,357,224. See also, Ador Published U.S. App. No. 20020112916; Price Published U.S. App. No. 20020158098; Gelman Published U.S. App. No. 20030159887; Richardson Published U.S. App. No. 20040140152; Fischer et al. Published U.S. App. No. 20060011415; Harris Jr. Published U.S. App. Nos. 20060113147 and 20100122874; Moon et al Published U.S. App. No. 20070158139; and Botti Published U.S. App. No. 200702460298.

### SUMMARY OF THE INVENTION

It is the principal object of the present invention to provide an improved controlled descent system that can be used by individuals of various ages and body builds to escape a high elevation emergency. A related object is to provide an EDS which is fail-safe for descent from a burning structure, either home or office building.

Another object is to provide a fire escape EDS which can be quickly and easily attached at one end to a sturdy object in the emergency area, even the opposite end of a door handle or other structural fixture, then rapidly stepped into and used for lowering oneself to safety. The counter-rope for this EDS can be stored until needed and then tossed to a safe descent point, most often the ground below or a lower level rooftop from which further evacuation can be achieved.

A further object is to provide an emergency descent controller with characteristics that will enable its user to don the device and affect a safe, slow descent despite the inherent panic that often ensues in a fire or other life-threatening situation.

In accordance with the foregoing objects, the present invention is embodied in an improved EDS for lowering someone along a rope from an elevated position to a relatively lower, safe position. The system includes fireproof rope or cable, a purposefully designed control descent rack in and through which that rope/cable is wound and a friction braking handle described in more detail below.

The invention contemplates an emergency descent kit or package which may be held in reserve and used when needed. Stored with that kit, stored in a bag or package, is a descent rope harness that would include a loop or hook fastening device at one end for securing to a fixed object at the elevated position. After fixing the rope to a support, the user drops the case and rope supply to the ground. The user then steps a first leg into the harness, then his/her other leg into a second harness leg loop, before connecting the other vest portions/straps about his/her chest and using the EDS to lower him/herself to safety.

### BRIEF DESCRIPTION OF FIGURES

FIG. 1 is a front close up view of one preferred embodiment fastened about the chest of its wearer/user;

FIGS. 2 through 15 show various sub-components of this invention in certain stages of assembly, the elements and assembly steps for same described in greater detail below. Particularly, FIG. 2 is a top plan view of the Chest Strap component secured about the lower ladder rung of the Emergency Descent System Rack (EDSR) critical to this invention;

FIG. 3 is a top plan view of the Kevlar® Shield, (L) Chest Strap and Kevlar® Brake Support double heavy sewn to (L) Shoulder Strap with 207 Kevlar® thread;

FIG. 4 is a top plan view showing the mark situated above the (L) Chest Strap on (L) Shoulder Strap and the Kevlar® Brake Support folded up to that mark;

FIG. 5 is a top plan view showing the top of the Brake Support hot melt glued and heavy sewn to the top edge of (L) Chest Strap;

FIG. 6 is a side perspective view showing the Chest Buckle Strap secured through a lower aperture on the EDSR with its Floating Bar Buckle;

FIG. 7 is a top plan view showing how the (R) Chest Buckle Strap is centered on and then hot melt glued to the top of (R) Shoulder Strap;

FIG. 8 is a top plan view after the (R) Chest Buckle Strap is double heavy sewn to the (R) Shoulder Strap with 207 Kevlar® thread;

FIG. 9 is a top plan view showing the two Shoulder Straps connected through and to the EDSR;

FIG. 10 is a top plan view showing the pieces of 2″ Flame Resistant Reflective Tape hot melt glued and sewn onto both Shoulder Straps, above the Chest Strap in the front and above the Rear Crossing Sew Line;

FIG. 11 is a top plan view showing the Kevlar® Brake ends being hot melt glued together at a 45 degree angle according to one preferred embodiment;

FIG. 12 is a top view photograph showing the Brake Strap ends being folded to overlap, then hot melt glued and double heavy sewn with 207 Kevlar® thread

FIG. 13 is a top plan view line drawing of FIG. 12;

FIG. 14 is a perspective rear view showing the upper vest component of this invention as situated between the shoulder blades on the back of a wearer;

FIG. 15 is a top view photograph showing the two front shoulder straps with reflective tape thereon as connected at opposite ends to the lowest aperture of the EDSR;

FIG. 16 is a front perspective close up view of the upper vest component of this EDS installed on a mannequin;

FIG. 17 is a front perspective view of the upper vest component of the full EDS harness installed on a mannequin;

FIG. 18 is a right side perspective view showing the rope leaving the EDS beneath the right arm and middle back of a mannequin;

FIG. 19 is a side perspective close up view showing one embodiment of the rope from the EDS threaded through the Brake strap and into the lower aperture of the EDSR;

FIG. 20 is a front plan view showing the preferred pattern of rope threading through an EDSR according to the present invention;

FIG. 21 is a front plan close up view of the full EDS harness installed on a mannequin; and

FIG. 22 is a rear plan view of the EDS from FIG. 21 installed on a mannequin.

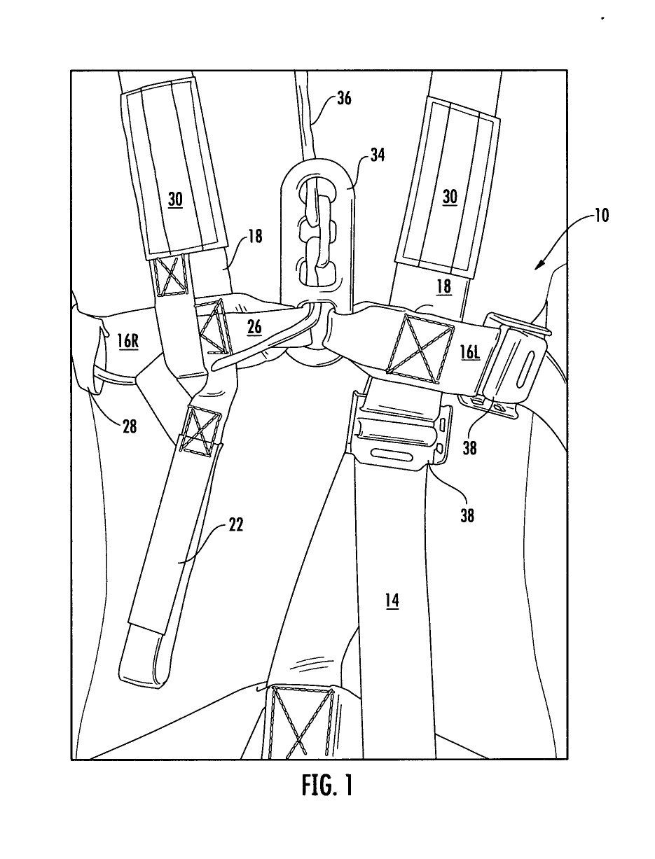

### DESCRIPTION OF PREFERRED EMBODIMENTS

The particular components to the preferred embodiment, generally 10, shown in the accompanying FIGURES consist of: 2 leg loops 12L, 12R (each 38″ long) of 2″ webbing; a leg strap 14, 40″long of 2″ webbing; a right chest strap 16R, 70″ long of 2″ webbing; a shoulder strap 18, 51″ long of 2″ webbing; a left chest buckle strap 16L, 12″ long of 2″ webbing; a Kevlar® brake strap 22, 22″ long of 1″ webbing; a Kevlar® brake support 24, 6″ long of 1″ webbing; a Kevlar® line shield 26, 7½″ long of 1″ webbing; a Kevlar® line tube 28, 7″ long of 2″ Kevlar® tubular webbing; 4 pieces of flame resistant reflective tape 30, (lime colored), 2″ wide, 5″ long; flame resistant reflective tape 32, (silver colored), 1″ wide, 5″ long; an Emergency Descent System (EDS) Rack 34; at least 50 feet of Tech 12 Technora® braided line 36, 3/16 diameter, 5600 lb. capacity; sections of 138 Kevlar® thread and 207 Kevlar® thread; 2 floating bar buckles 38.

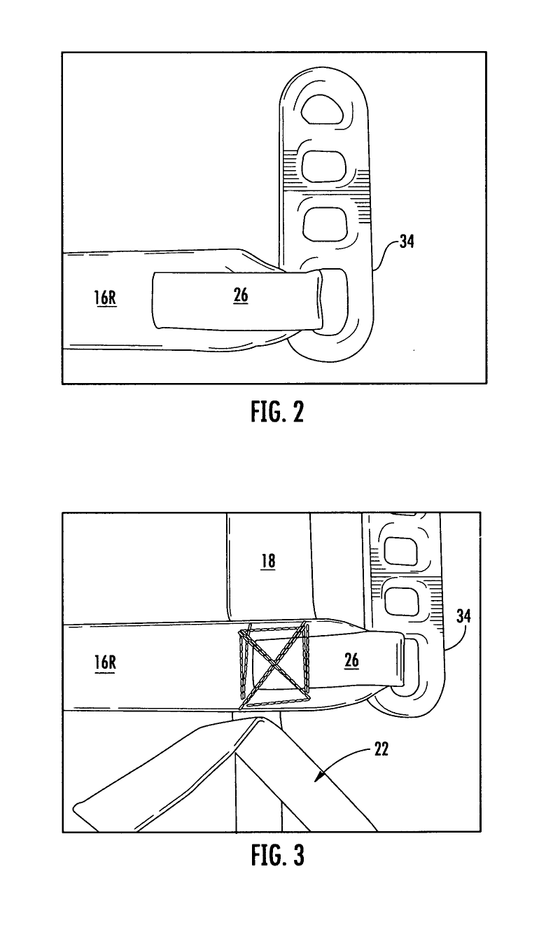

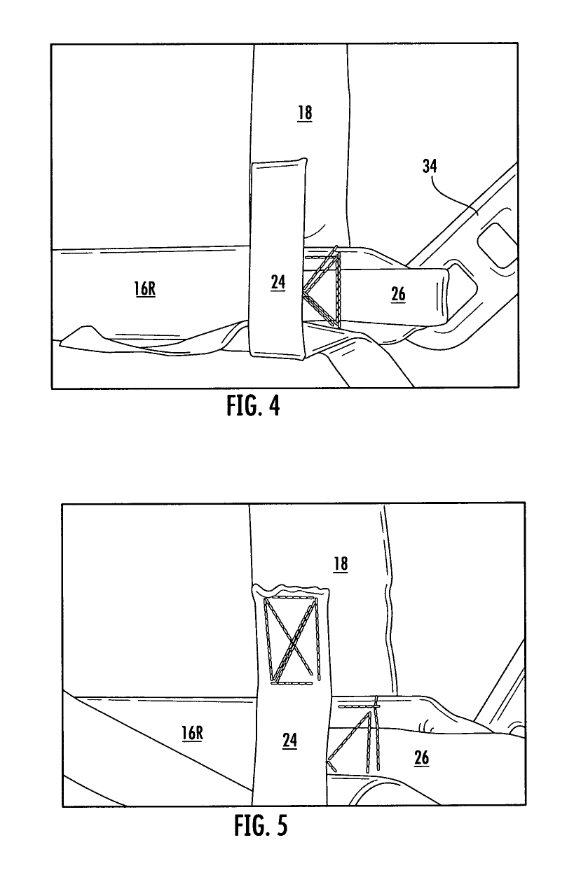

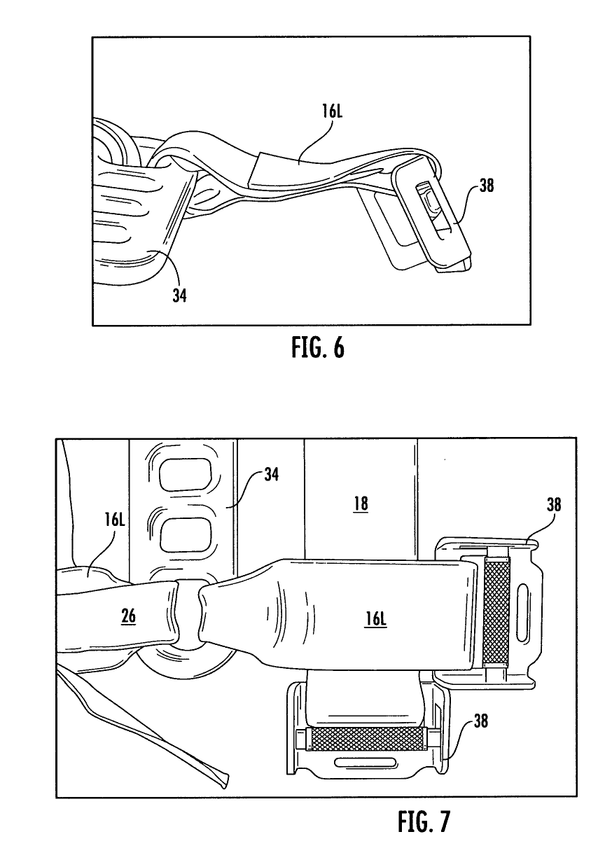

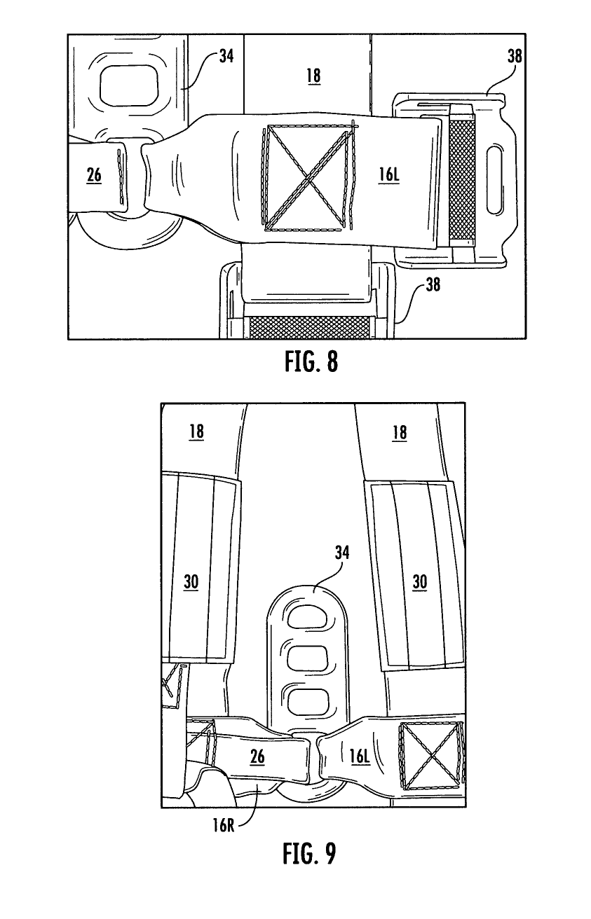

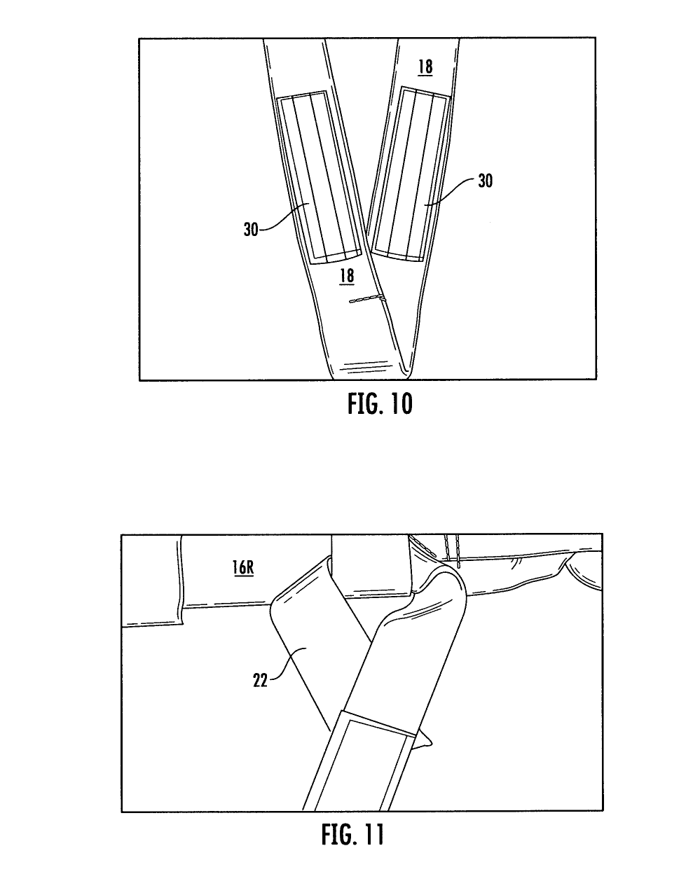

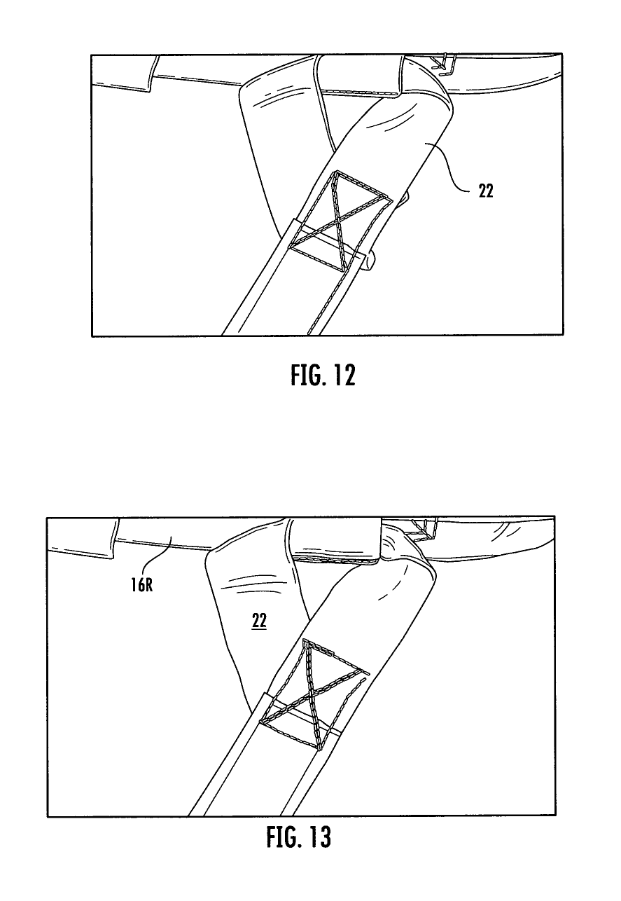

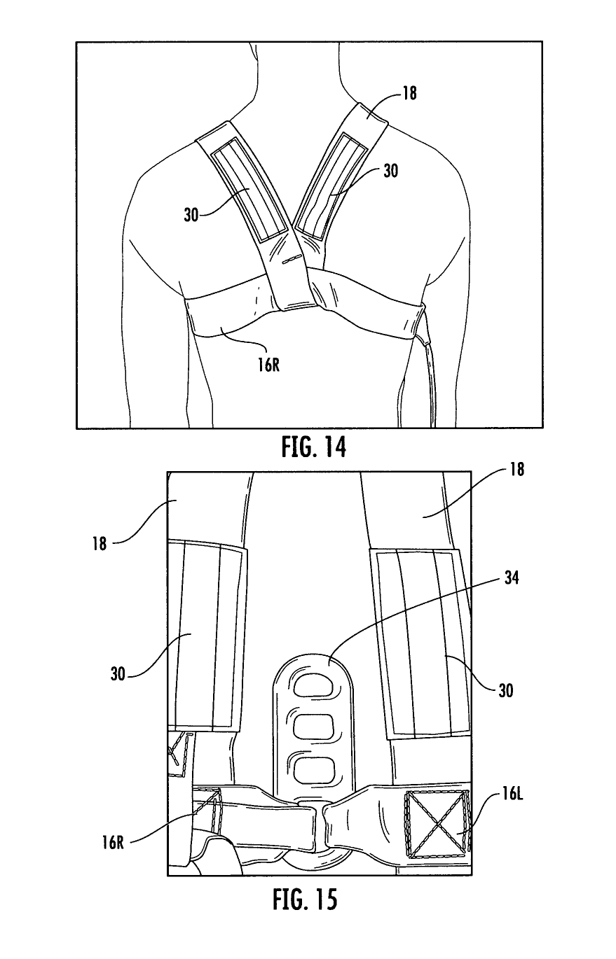

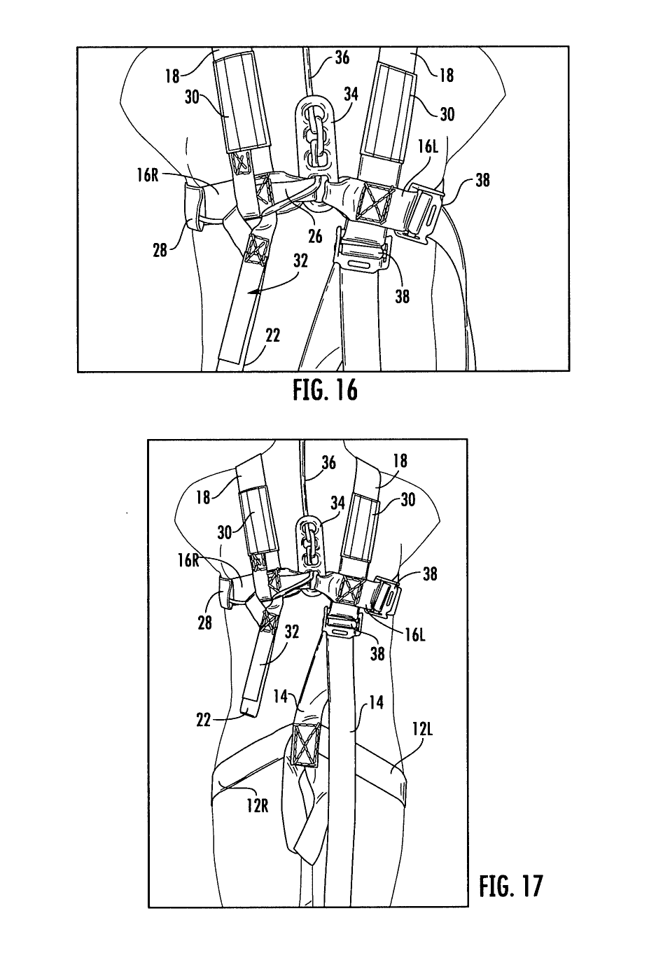

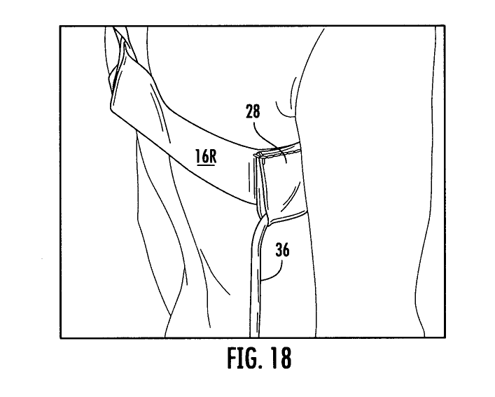

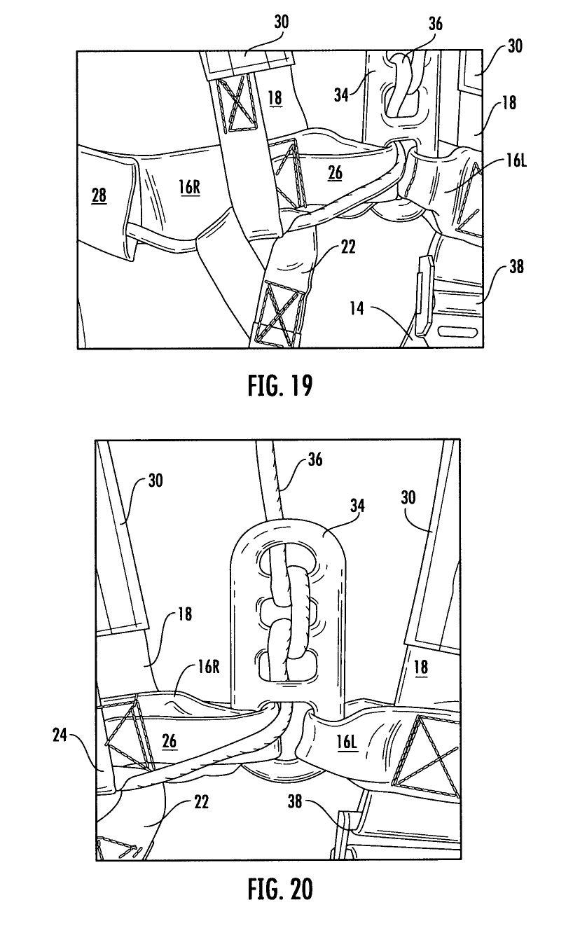

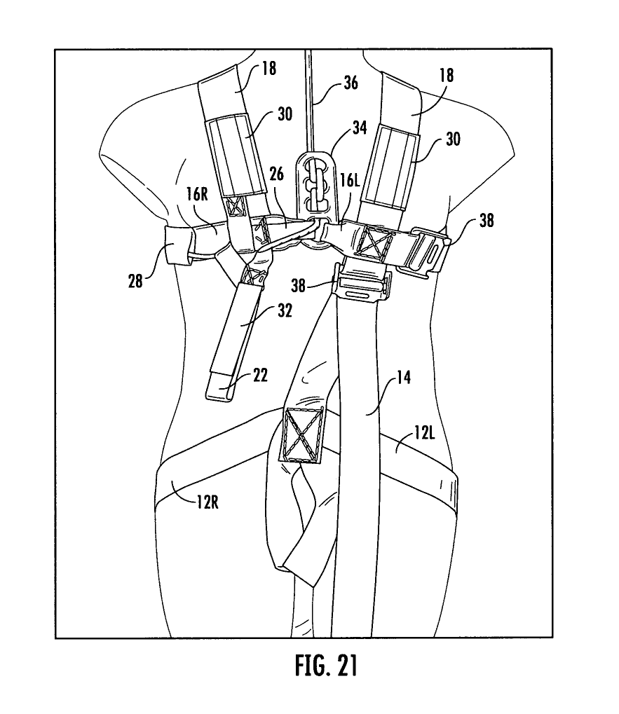

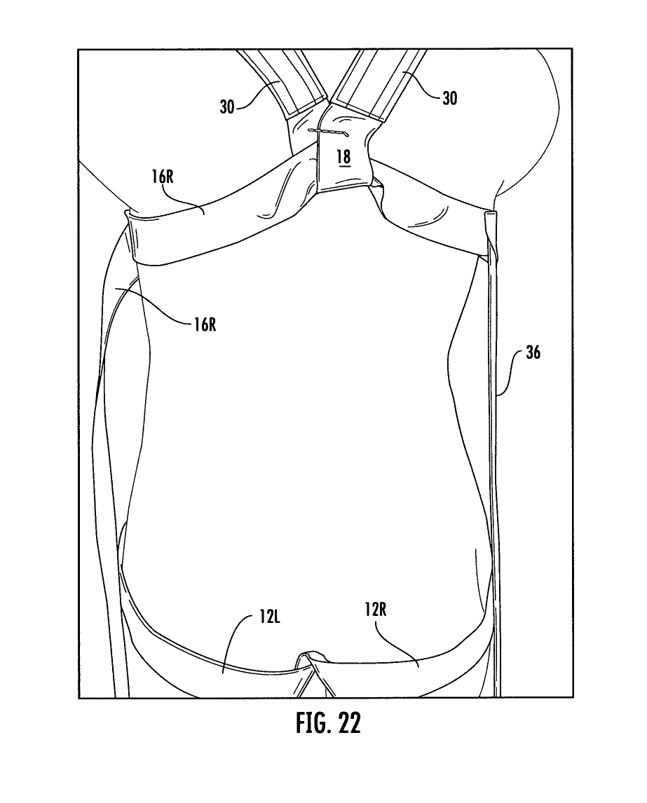

For the preferred construction of this embodiment (as shown), the following steps were taken:
Step 1: Mark 70″ ([L]R) Chest Strap 16R 4″ from one end.
Step 2: Fold at this mark in 3rds and Hot Melt Glue (HMG) in place.
Step 3:HMG 7 ½″ Kevlar® Line Shield 26 to ([L]R) Chest Strap 16R flush with end.
Step 4: Sew Kevlar® Line Shield 26 to ([L]R) Chest Strap 16R at fold center with
   Kevlar® 138 thread.
Step 5: HMG ([L]R) Chest Strap 16R to ([L]R) side of Emergency Descent System Rack (EDSR) 34. Folded sewn center of ([L]R) Chest Strap 16R will be on inside center of EDSR 34. See, FIG. 2.
Step 6: Make a mark at 3¾″ on the 51″ Shoulder Strap 18, fold over to this mark.
Step 7: Make a mark at 4″ from fold and separate both sides until the top of the formed V separates at that mark and HMG. The ([L]R) side is 23½″ and the ([R]L) side is 27¼″.
Step 8: Make a mark 2¼″ from fold and sew at this point 1″ wide with 138 Kevlar® thread.
Step 9: Mark 6″ Kevlar® Brake Support 24 on (L) side at 1¼″ and 2¼″ on (R) side from same end.
Step 10: HMG and sew 5″of 1″ Fire Resistant Reflective Tape 32 8″ from end of 22″ Kevlar® Brake Strap 24. Sew with 138 Kevlar® thread.
Step 11: Mark 22″ Kevlar® Brake Strap 22 3″ on (R) side from same end.
Step 12: Position Kevlar® Brake Strap 22 on top of the Kevlar® Brake Support 24 so the 3″ mark is aligned with the 1¼″ mark on the (L) side of the Kevlar® Brake Support 24 and the (L) edge of the Kevlar® Brake Strap 22 is aligned with the 2¼″ mark on the (R) side of the Kevlar® Brake Support 24. HMG at the 2¼″ mark.
Step 13: Sew with 138 Kevlar® Thread 1″ along the 2¼″ mark, sewing the Kevlar® Brake Strap 22 to the Kevlar® Brake Support 24.
Step 14: HMG the Front of the Kevlar® Brake Support 24 to the REAR of the ([L]R) Chest Strap 16L. Align the top of the Kevlar® Brake Support 24 with the top edge of the ([L]R) Chest strap 16R and align the (R) side of the Kevlar® Brake Support 24 with the folded end edge of the ([L]R) Chest Strap 16R.
Step 15: HMG ([L]R) Chest Strap 16R over the end of the 23½″ ([L]R) share of Shoulder Strap 18. Place the bottom edge of the ([L]R) Chest Strap 16R even with the bottom of the ([L]R) share of Shoulder Strap 18. The outside edge of the ([L]R) share of Shoulder Strap 18 will be even with the outside edge of the Kevlar® Brake Support 24.
Step 16: Double heavy sew Kevlar® line Shield 26, ([L]R) Chest Strap 16R, Kevlar® Brake Support 24, to ([L]R) share of Shoulder Strap 18 with 207 Kevlar® thread. See, FIG. 3.
Step 17: Make mark 1½″ above ([L]R) Chest Strap 16R on ([L]R) share of Shoulder Strap 18. Fold Kevlar® Brake Support 24 up to 1½″ mark per FIG. 4, HMG and heavy sew with 207 Kevlar® thread from top of Kevlar® Brake Support 24 to top edge of ([L]R) Chest Strap 16R. See, FIG. 5.
Step 18: HMG 7″ Kevlar® Line Tube 28 on ([L]R) Chest Strap 16R along the top edge only, 2″ from the Kevlar® Brake Support 24, and sew along top edge only with 138 Kevlar® Thread.
Step 19:Mark 12″ ([R]L) Chest Buckle Strap 16L 4″ from one end, fold in 3rds, HMG and sew at center of fold.
Step 20: Place ([R]L) Chest Buckle Strap 16L on EDSR 34 with Floating Bar Buckle 38. Place sewn center of fold with center of EDSR 34 and overlap webbing 2″ in the rear and HMG with Floating Bar Buckle 38 on far ([R]L) end. See, FIG. 6.
Step 21: Make a mark on the front of the ([R]L) 27¼″ long share of Shoulder Strap 18 6″ from end, place Floating Bar Buckle 38 on, fold up the end of ([R]L) share of Shoulder Strap 18 to the 6″ mark, HMG.
Step 22:Center and HMG ([R]L) Chest Buckle Strap 16L on top of ([R]L) share of Shoulder Strap 18. ([R]L) Chest Buckle Strap 16L top edge will be even with the top edge of the folded short end of the ([R]L) share of Shoulder Strap 18. See, FIG. 7.
Step 23: On the back side, the ([L]R) edge of the ([R]L) share of Shoulder Strap 18 will be even with the folded end of the ([R]L) Chest Buckle Strap 16L.
Step 24: Double heavy sew the ([R]L) Chest Buckle Strap 16L to the ([R]L) share of Shoulder Strap 18 with 207 Kevlar® thread. See, FIG. 8.
Step 25: HMG and sew with 138 Kevlar® thread the 4 pieces of 2″ Flame Resistant Reflective Tape 30 on both left and right shares of Shoulder Straps 18, at 1″ above the respective Chest Straps 16L, 16R in the front and 1″ above the Rear Crossing Sew Line. See, FIGS. 9 and 10.
Step 26: HMG ends of Kevlar® Brake strap 22 [ends] together at 45 degree angle after (1) turn forwards on the ([L]R) and (1) turn backwards on ([R]L). The ([R]L) long side will be in front and on top of ([L]R) short side end. FIG. 11. The top (R) corner of the Reflective Tape 30 will align with the (R) corner of the ([L]R) short end.
Step 27: Fold the long end of the Kevlar® Brake Strap 22 under and HMG it to the 45 degree angle crossing with the end extending to the V. Double Heavy Sew Kevlar® Brake Strap 22 overlaps with 207 Kevlar® thread. See, FIG. 13.
Step 28:Thread ([L]R) Chest Strap 16R through rear fold of Shoulder Strap 18 [Fold] and through ([R]L) Chest Strap Floating Bar Buckle 38.
Step 29: HMG both 38″ Leg Loops 12L, 12R by placing the bottom of one end over the top of the other end at a 45 degree angle.
Step 30: HMG one Leg Loop 12L on top of Leg Loop 12R by aligning both top straps at a 90 degree angle.
Step 31: HMG one end of the 40″ Leg Strap 14 over the combined end of both Leg Loops 12L, 12R.
Step 32: Double heavy sew Leg Strap 14 to both Leg Loops 12L, 12R with 207 Kevlar® thread.
Step 33: Fold the ends of both the Chest Strap 16R and Leg Strap 14 to the rear 1½″ and sew along fold.
Step 34: Attach Leg Strap 14 to ([R]L) side Shoulder Strap Floating Bar Buckle 38.
Step 35: Thread Technora® Line 36 through the Kevlar® Line Tube 28, Kevlar® Brake Strap 22 and up through the EDS Rack 34. See, FIGS. 18 through 20.
Step 36: Complete construction of the Firescape EDS™.

After assembly of the foregoing EDS per the steps outlined above, the unit 10 can be sold for use in an emergency. For any such use, the wearer/operator/user would first take the free end of the unit's fireproof rope exiting from the EDS rack and secure same to a fixed anchoring point such as a building fixture or possibly a sturdy attachment to a door or doorway. The rest of the rope/line would then be tossed from the elevated point where the user is at risk to a lower, possibly out a window or open doorway to a more secure region like the ground below or possibly a safer, building region like a lower rooftop. Once anchored and fully strapped in/on, the wearer/user can operate the present invention to safely descend slowly and controllably along the rope from his/her elevated point to the ground below or a lower rescue platform/region then not at risk.

The device provides a mechanical advantage by enabling its wearer to descend slowly along the rope as the rope hangs downwardly from an elevated point without having to selectively grip the rope. In one extreme or “deadman” position, components of this device grip the rope tightly and prevent a rapid, uncontrolled descent. In another position, these same components temporarily engage/grip the rope to prevent, or at least substantially retard, too rapid of a descent. In the normal descent position, this device engages components to frictionally engage the rope as the wearer controllably slides down and along to safety.

While intending to be a primary fire escape rescue apparatus, for either home or office use, it may also serve as a device for enabling descent from scaffolding, lifts, forklifts, trucks, stock pickers, snorkels, cranes, window washing platforms and the like.

Note that the brake mechanism for this embodiment of EDS works by pulling on the handle and not by letting the handle “go”. In other words, to increase pressure and thereby slow one's descent, the user/wearer must take the “additional” step of actually pulling . . . pulling down on the Kevlar® brake strap. Such pulling causes increased friction by pulling against the rope/cord/line in two different directions.

In operation, the EDS apparatus may be activated for a slow, controlled descent by releasing tension on its brake strap. That causes the rope to frictionally move through its descent rack while the user/wearer gradually slides down the other end of said rope. To stop or slow descent, the user/wearer may simply increase his/her pull on the brake, thereby causing the rope to re-engage or “wedge” in the system for hopefully just a temporary postponement of one's full descent to safety.

In use, a fireproof rope is woven through the fixed crossbars of the device's rack (or ladder) as best seen in the accompanying FIGS. By decreasing the brake/pull, this rope will loosen its selective gripping engagement with other EDS components thereby allowing its user/wearer to descend down and along the free length of said rope slowed by frictional engagement with the ladder/crossbars of the rack integrally included in this EDS harness system.

This invention represents a significant improvement over the harness-type system of Varner U.S. Pat. No. 5,070,962. At one end, the rope of this EDS is provided with a loop and/or other securing device to enable rope securement to a fixture within the confines of the elevated position. A free end of that rope can be housed in its own container (not shown). Ideally, that container, the EDS proper and related materials (including appropriate instructions) can be packaged in a common emergency kit/bag.

In use for descent from a window, door, porch, scaffold, lift truck or other platform, this EDS kit may be opened and the loop (or free) end of its rope secured in/at the elevated location. It may or may not include a hook, carabiner or other securing assist. The rope itself (in or outside of its own storage packet) would then be lowered from the elevated location. The user/wearer would don the harness about his/her chest and through both shoulder straps. He/she would step into both of the two integral leg straps and then utilize the EDS/harness to controllably descend along the free end of that rope to the ground or a lower safety/rescue point.

This invention is much easier to put on than a full body device. One places the device over one's head and places his/her arms into the top vest component before stepping into the two leg straps and tightening all adjustable straps and/or buckles. Even with rapid adjustment, the invention should take less than one minute to put on . . . more likely less than about 30 seconds. And, in an emergency, time is of the essence. Every second saved could prove critical. Once the device is in place on the wearer's body, he/she can deploy the rope/line, connect one end to a fixture in the building and drop the other end to safety.

While certain illustrative embodiments have been shown in the drawings and described above in considerable detail, it should be understood that there is no intention to limit the invention to the specific forms disclosed. On the contrary the intention is to cover all modifications, alternative constructions, equivalents and uses falling within the spirit and scope of the invention as expressed in the appended claims.

What is claimed is:

1. An emergency system for use by an individual in a building for descending to a safe rescue region in an emergency, said system comprising:
an upper vest component for securing about a chest region of the individual, said vest component including an integral rack;
a lower component for securing about a first upper leg of the individual and a lower component for securing about a second upper leg of the individual;
an elongate section of rope stored outside the upper vest component until needed to gradually descend to the safe rescue region, said rope intended for securing at one end to a fixture from which the individual can effect gradual descent along an opposite end as said rope frictionally engages with the integral rack of the upper vest component; and
a frictional brake strap through which the rope passes for slowing down or completely stopping descent by the individual increasing his/her pull on the brake strap.

2. The emergency system of claim 1 wherein the rope is fire resistant.

3. The emergency system of claim 1, which includes at least 50 feet of rope.

4. The emergency system of claim 1 wherein said rope may be stored in a packet until needed.

5. The emergency system of claim 1, which includes an indicator for directing the individual through which straps to slip his/her arms and legs.

6. The emergency system of claim 1, which includes at least one frictional brake strap for allowing the individual to slow down or stop descent.

7. The emergency system of claim 1 wherein the integral rack is locatable for positioning in front of the individual's chest region.

8. The emergency system of claim 1, which is available in adult and teen sizes.

9. The emergency system of claim 1, which may be used by an adult alone or an adult and child combination weighing up to 500 lbs.

10. A harness for supporting its wearer during a controlled descent along a support line running through the harness from a higher elevation to a lower elevation in an emergency, said harness comprising:
means for fastening around the upper chest and over the shoulders of its wearer, a front region of said fastening means including an integral rack;
means for fastening about both upper thighs of its wearer; and
an elongate section of support line for securing at one end to a fixture in the higher elevation and from which the wearer can effect gradual descent along an opposite end as said support line frictionally engages with the integral rack.

11. The harness of claim 10 wherein said support line is made from fire resistant material.

12. The harness of claim 10, which includes at least 50 feet of support line.

13. The harness of claim 10, wherein said support line may be stored in a packet until needed.

14. The harness of claim 10, which includes markings for directing the wearer where to situate his/her arms.

15. The harness of claim 10, which includes at least one frictional brake strap for allowing its wearer to slow down or stop descent.

16. The harness of claim 10, which includes a plurality of straps and buckles for adjusting to better fit about its wearer.

17. A method for using a harness to escape from a building in an emergency, said method comprising:
(a) providing a harness that comprises:
means for fastening around the chest and over the shoulders of its wearer, a front region of said fastening means including an integral rack;
means for fastening about both upper thighs of its wearer;
an elongate section of rope for securing at one end to a fixture in the higher elevation and from which the wearer can effect gradual descent along an opposite end as said rope frictionally engages with the integral rack; and
at least one frictional brake strap for allowing the wearer to slow down or stop descent,
(b) situating the wearer's arms and legs in the harness and adjusting it to fit securely about the wearer's chest and upper thighs;
(c) securing one end of said rope to a fixture in said building which should be capable of supporting the wearer's weight for at least a limited amount of escape time;
(d) locating an opposite end of said rope to a secure lower region; and
(e) positioning one or both hands of the wearer in the frictional brake strap for controlling the rate of descent along the rope until reaching the secure lower region.

18. The method of claim 17 wherein the secure lower region is the ground.

19. The method of claim 17 wherein the secure lower region is a rooftop from which further rescue may be planned.

20. The method of claim 17 wherein the rope is fire resistant.
